(19) United States
(12) Patent Application Publication
(10) Pub. No.: US 2001/0003467 A1
(43) Pub. Date: Jun. 14, 2001

(54) Video display apparatus

(76) Inventor: Kazuo Mochizuki, Tokyo (JP)

Correspondence Address: McGinn & Gibb, PLLC, 8321 Old Courthouse Road, Suite 200, Vienna, VA, 22182-3817, US

(21) Appl. No.: 09/729,245

(22) Filed: Dec. 5, 2000

(30) Foreign Application Priority Data
Dec. 8, 1999 (JP) 348261/1999

(51) Int. Cl. H04N 7/01; H04N 11/20

(52) U.S. Cl. 348/458; 348/425.3; 348/440.1; 348/443; 348/448

(57) ABSTRACT

A video display apparatus includes a display device, resolution conversion unit, and display position setting unit. The resolution conversion unit converts the resolution of an input video signal into that of the display device. The display position setting unit sets the display position of a first video signal in each field to be displayed on the display device on the basis of the temporal relationship between a time from generation of a vertical sync signal to input of the first video signal and the generation timing of a horizontal sync signal.

### BACKGROUND OF THE INVENTION

The present invention relates to a video display apparatus and, more particularly, to a video display apparatus for converting the resolution of an input video signal into that of a display device and displaying the converted video signal.

A video display apparatus represented by a liquid crystal display apparatus having display pixels arrayed in a dot matrix converts the number of scan lines to adjust the final number of scan lines to the number of pixel lines of the display device from the structural viewpoint in displaying a video signal having a different number of scan lines. Conversion of the number of scan lines adopts a method using a line memory and a method using a frame memory for converting the frame frequency in addition to the number of scan lines. Any method converts the number of scan lines by processing an input signal as a two-dimensional video signal and performing interpolation operation in the vertical direction (column direction).

At this time, to selectively display a noninterlaced signal represented by a signal of a personal computer and an interlaced signal represented by an NTSC (National Television System Committee) video signal, the first scan position on the display screen must be changed in successive display fields.

An interlaced signal display method will be described with reference to FIGS. 7 and 8. FIGS. 7 and 8 show the locus of a signal scanning a display screen from the upper left to the lower right. With reference to FIG. 7, scan of the enter display screen is completed by two vertical scan operations such that scan is done by every second scan lines 1, 2, 3, and 4, and then by every second scan lines 5, 6, and 7 so as to interlace the scan lines 5, 6, and 7 with the first scan lines 1, 2, 3, and 4. An image obtained by the first scan of the scan lines 1, 2, 3, and 4 is called an odd field, and an image obtained by the second scan of the scan lines 5, 6, and 7 is called an even field. The odd and even fields form a 1-frame image. For example, the NTSC television scheme uses 525 scan lines 1 to 263, and 263′ to 525′, as shown in FIG. 8. To the contrary, a noninterlaced signal display method forms one frame by one scan.

More specifically, the first scan position (start point A of the scan line 1 in FIG. 7) of a noninterlaced signal is always constant on a display screen having successive display fields, whereas that of an interlaced signal must be changed every field. Most of interlaced signals generally adopt 2:1 interlaced scanning, and scan shown in FIG. 7 also represents 2:1 interlaced scanning. With reference to FIG. 7, the start point of the first scan is the point A, and that of the second scan is a point B located at ½the scan line. The vertical positions of odd and even fields are apart by a period C of ½the scan line.

Conventionally, a display apparatus having display pixels in a dot matrix determines the order of odd/even fields for an input signal in displaying a 2:1-interlaced signal. That is, if an odd field is displayed from the first pixel on the display device, an even field is displayed at a position vertically shifted by a ½line, thereby performing actual interlaced scanning.

Other examples of frequency-converting an input signal into a signal suited for a display device are disclosed in Japanese Patent Laid-Open Nos. 5-268611 (reference 1), 8-65639 (reference 2), and 9-307787 (reference 3). Reference 1 describes a technique of delaying a vertical sync signal by ½the horizontal sync period of an even field to superimpose even and odd fields. Reference 2 describes a technique of determining field interlacing from input- and output-side vertical sync signals to always perform interlacing in units of frames.

Reference 3 describes a technique of setting in advance a set value for superimposing an even field on an odd field and a set value for superimposing an odd field on an even field, selecting either one of the set values by a selection signal, and generating a control signal for starting vertical scan of odd and even fields on the basis of the selected set value.

However, in detecting whether an input signal represents an odd or even field, the conventional video display apparatus may cause a detection error under the influence of noise or an equivalent pulse superposed on a horizontal sync signal around a vertical sync signal. References 1 to 3 described above do not disclose any means for solving this problem.

### SUMMARY OF THE INVENTION

It is an object of the present invention to provide a video display apparatus capable of converting the resolution of an input signal into that of a display device and displaying the converted signal without performing field detection of the input signal or the like.

To achieve the above object, according to the present invention, there is provided a video display apparatus comprising a display device, resolution conversion means for converting a resolution of an input video signal into a resolution of the display device, and display position setting means for setting a display position of a first video signal in each field to be displayed on the display device on the basis of a temporal relationship between a time from generation of a vertical sync signal to input of a first video signal and a generation timing of a horizontal sync signal.

### BRIEF DESCRIPTION OF THE DRAWINGS

FIG. 1 is a block diagram showing a video display apparatus according to an embodiment of the present invention;

FIGS. 2A to 2D are timing charts showing input signals to a timing control circuit and VRAM shown in FIG. 1;

FIGS. 3A to 3C are timing charts showing input signals to a display device and driving circuit shown in FIG. 1;

FIG. 4 is a view showing a display example on the display device shown in FIG. 1;

FIGS. 5A to 5D are timing charts showing odd/even field determination operation;

FIGS. 6A to 6D are timing charts showing display control operation;

FIG. 7 is a view showing a 2:1-interlaced signal display method; and

FIG. 8 is a view showing an NTSC television display method.

### DESCRIPTION OF THE PREFERRED EMBODIMENT

The present invention will be described in detail below with reference to the accompanying drawings.

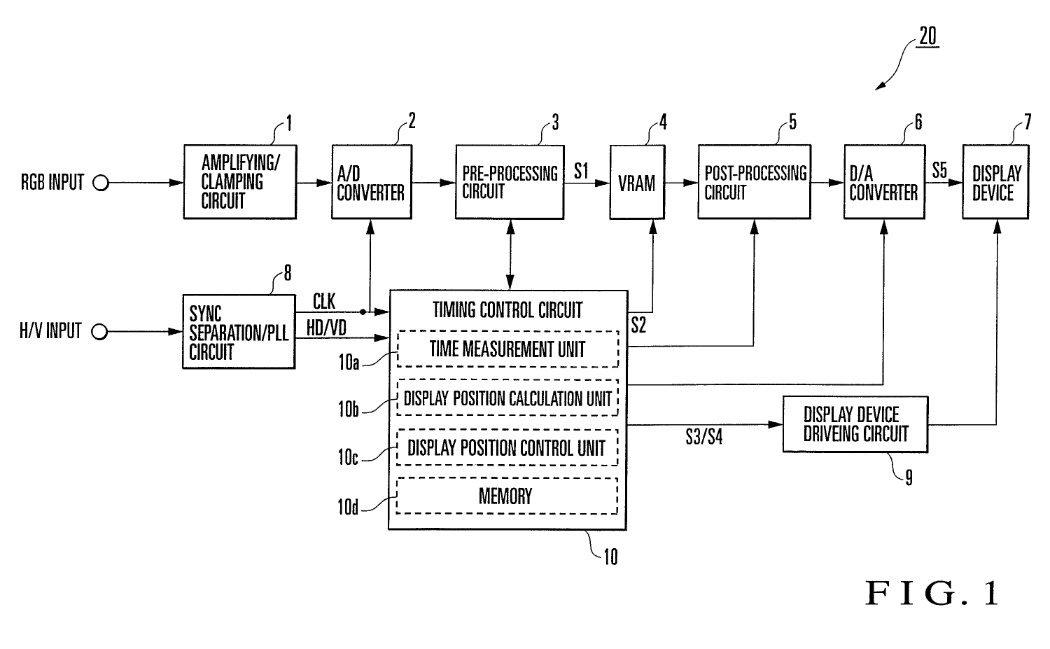

FIG. 1 shows a video display apparatus according to an embodiment of the present invention. Referring to FIG. 1, a video display apparatus 20 of this embodiment comprises an amplifying/clamping circuit 1 for receiving a video (RGB) signal, an A/D (Analog-to-Digital) converter 2 for converting an analog signal output from the amplifying/clamping circuit 1 into a digital signal, a pre-processing circuit 3 for pre-processing the digital signal output from the A/D converter 2, a VRAM (Video Random Access Memory) 4 for storing processing result information output from the pre-processing circuit 3, a post-processing circuit 5 for reading out the processing result information from the VRAM at a predetermined timing, a D/A (Digital-to-Analog) converter 6 for converting a digital signal output from the post-processing circuit 5 into an analog signal, and a display device 7 for displaying the analog signal output from the D/A converter 6.

The video display apparatus 20 further comprises a sync separation/PLL (Phase Locked Loop) circuit 8 for receiving a horizontal sync signal (HD) and vertical sync signal (VD), a display device driving circuit 9 for driving the display device 7, and a timing control circuit 10 serving as a display position setting means for controlling the pre-processing circuit 3, VRAM 4, post-processing circuit 5, D/A converter 6, and display device driving circuit 9. An example of the display device 7 is a liquid crystal panel adopted in a liquid crystal projector, liquid crystal monitor, or the like.

The timing control circuit 10 is constituted by a time measurement unit 10a for measuring a time from a vertical sync signal to a position at which display should start, a display position calculation unit 10b for calculating a specific vertical display position from the measured time, a display position control unit 10c for changing the display position of a video signal on the display device 7 for each field on the basis of outputs from the time measurement unit 10a and display position calculation unit 10b in converting the resolution of the video signal into that of the display device 7 and displaying the converted video signal, and a memory 10d for storing the time measured by the time measurement unit 10a for each field.

The operation of the video display apparatus 20 will be explained. An input video (RGB) signal is appropriately amplified and clamped by the amplifying/clamping circuit 1, and converted from an analog signal into a digital signal by the A/D converter 2. An output from the A/D converter 2 is processed by the pre-processing circuit 3, VRAM 4, and post-processing circuit 5 to convert the number of scan lines (resolution) of the input signal into the resolution of the display device 7. The converted signal is converted from a digital signal to an analog signal by the D/A converter 6, and supplied to the display device 7. When the display device 7 is a liquid crystal panel, D/A conversion must be executed, but when the display device 7 is a device which can be directly driven by a digital signal, D/A conversion need not be executed.

The sync separation/PLL circuit 8 receives a horizontal sync signal (HD) and vertical sync signal (VD), and regenerates a clock signal CLK by sync separation and PLL. The clock signal CLK regenerated by the sync separation/PLL circuit 8 is supplied to the A/D converter 2 and timing control circuit 10. The sync separation/PLL circuit 8 supplies the horizontal sync signal (HD) and vertical sync signal (VD) to the timing control circuit 10.

A resolution conversion means made up of the pre-processing circuit 3, VRAM 4, and post-processing circuit 5 converts the resolution of an input signal into that of the display device 7 in accordance with an output signal from the timing control circuit 10.

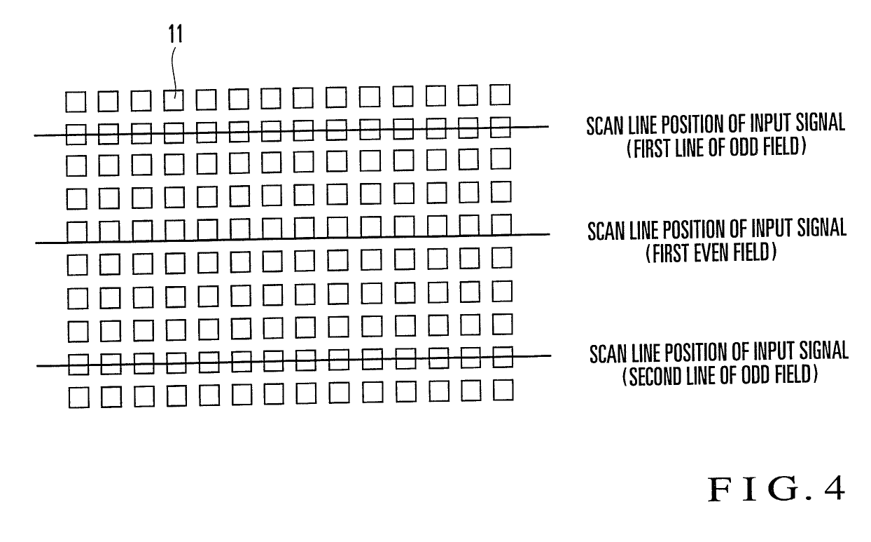

FIG. 4 shows a display example on the display device 7. As shown in FIG. 4, the resolution is converted by setting the scan line position of an input signal for a plurality of display pixels 11 arrayed in a matrix (column x row), and performing vertical interpolation processing. That is, the first line of an odd field is set on a predetermined row line, and the second line of the odd field is set on a predetermined lower row line. Similarly, the third and subsequent odd fields are set.

The first even field is set on an intermediate row line between the first and second lines of the odd field. However, the number of rows between the first and second lines of the odd field is not necessarily odd. If the number of rows is even, the first even field is not accurately set on a row line as shown in FIG. 4. In FIG. 4, the first even field is set between row lines. In this case, the first even field is set on a predetermined row line (e.g., a row line nearest to the intermediate row) from the weighted mean value of the first and second lines of the odd field. Similarly, the second and subsequent even fields are set.

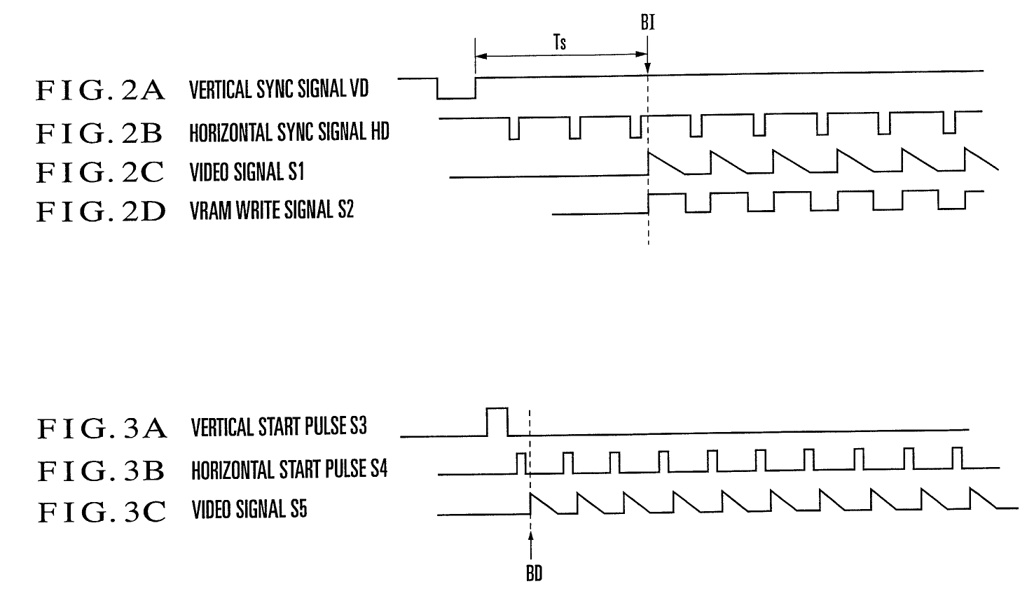

FIGS. 2A to 2D show the vertical sync signal VD and horizontal sync signal HD input to the timing control circuit 10, a video signal S1, and a VRAM write signal S2. As shown in FIGS. 2A and 2C, the timing control circuit 10 measures a time Ts from the rise (leading edge) of the vertical sync signal VD to the start point of the video signal S1 (output timing of the VRAM write signal), and stores the time Ts in the memory 10d. The time Ts is used for calculation of a scan line position by the post-processing circuit 5 (to be described later).

The temporal relationship between the video signal S1, vertical sync signal VD, and horizontal sync signal HD on the input side is determined on the video source side. A first video data point BI is set at the start point of the video signal S1, and write in the VRAM 4 starts in accordance with the VRAM write signal S2 (FIG. 2D). The first video data point BI, i.e., first video signal means not the first video signal on the video supply apparatus side, but the first video signal displayed for each field in the video display apparatus.

FIGS. 3A to 3C show a vertical start pulse S3 and horizontal start pulse S4 output from the timing control circuit 10, and a video signal S5. Only the video signal S1 having passed through the amplifying/clamping circuit 1, A/D converter 2, and pre-processing circuit 3 is written in the VRAM 4. To display the video signal S5 at a display device driving timing, read from the VRAM 4 is done at a display start point BD of the display device 7 to extract the video signal S5. At this time, the number of horizontal start pulses S4 output from the timing control circuit 10 is set in accordance with the number of display pixels.

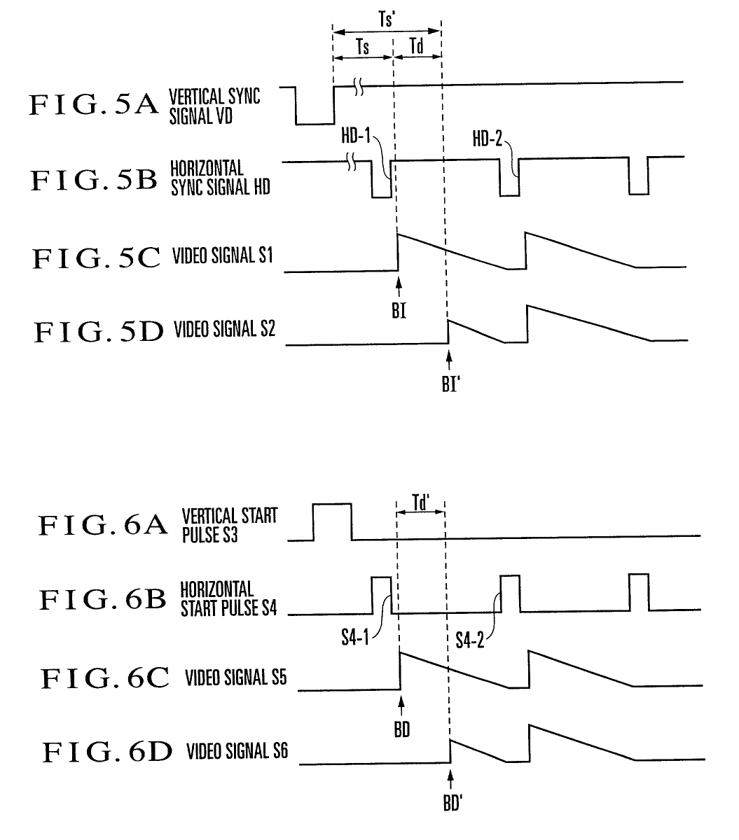

A detailed operation of the timing control circuit 10 will be explained with reference to FIGS. 5A to 5D and 6A to 6D. In the following description, a 2:1-interlaced signal input to the timing control circuit 10 is displayed on the display device 7 by interlaced scanning.

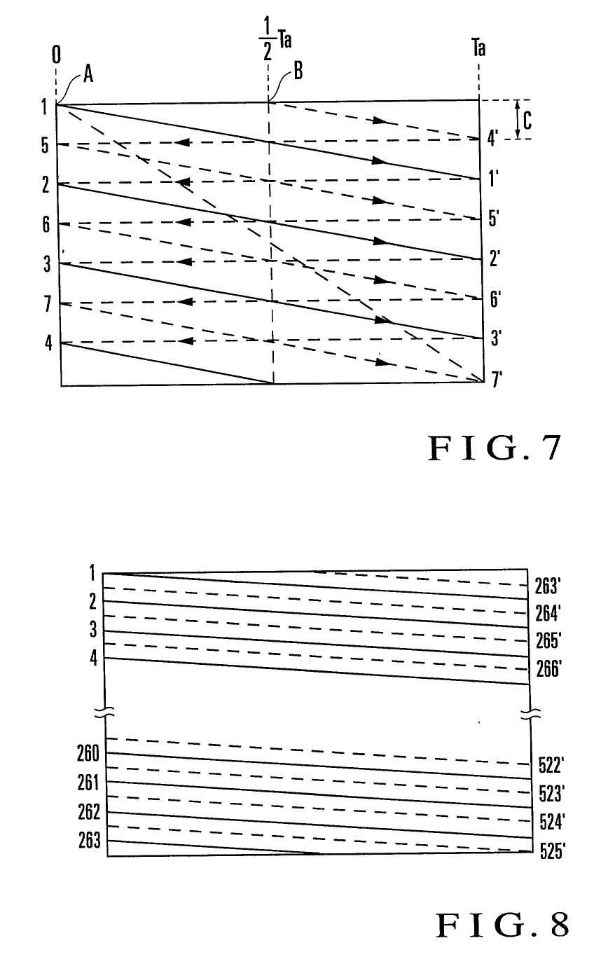

As shown in FIGS. 5A and 5C, the time measurement unit 10a of the timing control circuit 10 measures the time Ts from the rise time of the vertical sync signal VD to the start point BI of the video signal S1 of the first field. The time Ts measured by the time measurement unit 10a is stored in the memory 10d for each field. The display position calculation unit 10b of the timing control circuit 10 monitors the temporal relationship between the time Ts stored in the memory 10d and rise HD-1 (FIG. 5B) of the horizontal sync signal HD. In FIGS. 5A and 5B, the end timing of the time Ts is immediately after the rise HD-1 of the horizontal sync signal HD. In this case, the display position calculation unit 10b of the timing control circuit 10 determines that the input video signal S1 is a video signal of an odd field. With reference to FIG. 7, the display position calculation unit 10b determines that the video signal S1 is a signal which should be scanned from an upper left point A.

As shown in FIGS. 6A and 6B, the generation timings of the vertical start pulse S3 and horizontal start pulse S4 output from the timing control circuit 10 are set in advance in accordance with the layout of the display pixels 11 of the display device 7. When the input video signal S1 is a video signal of an odd field, the display position control unit 10c of the timing control circuit 10 sets a display start timing BD of the display device 7 to be immediately after rise S4-1 of the horizontal start pulse S4 generated immediately after the vertical start pulse S3 is generated. Then, the timing control circuit 10 uses this display start timing BD as a reference to drive the display device driving circuit 9 so as to display the video signal S5 read out from the VRAM 4 on the display device 7.

The timing control circuit 10 monitors a video signal S2 (FIG. 5D) of the second input field, and measures a time Ts′ (FIG. 5A) from the rise timing of the vertical sync signal VD to a start point BI′ of the video signal S2. The measured time Ts′ is stored in the memory 10d in correspondence with the field. At the same time, the display position calculation unit 10b of the timing control circuit 10 determines the temporal relationship between the measured time Ts′ and the rise HD-1 (FIG. 5B) of the horizontal sync signal HD. In FIGS. 5B and 5D, the start point of the video signal S2 is an almost intermediate point BI′ between the rise timing HD-1 of the horizontal sync signal HD and a rise timing HD-2 of the next horizontal sync signal HD. In this case, the display position calculation unit 10b of the timing control circuit 10 determines that the second input video signal S2 is a video signal of an even field. With reference to FIG. 7, the display position calculation unit 10b determines that the video signal S2 is a signal which should be scanned from an intermediate point B in the horizontal scan period.

When the input video signal S2 is a video signal of an even field, the display position control unit 10c of the timing control circuit 10 sets a display start timing BD′ of the display device 7 to be an intermediate point between the rise S4-1 of the horizontal start pulse S4 generated immediately after the vertical start pulse S3 is generated, and rise S4-2 of the next horizontal start pulse S4, as shown in FIG. 6D (to be described later). The timing control circuit 10 uses the display start timing BD′ as a reference to drive the display device driving circuit 9 so as to display the video signal S5 read out from the VRAM 4 on the display device 7. In this manner, input interlaced signals are interlace-displayed on the display device 7.

When the start points of the input video signals S1 and S2 are always the time (point BI in FIG. 5C) immediately after the rise HD-1 of the horizontal sync signal HD from the determination result of the display position calculation unit 10b, the timing control circuit 10 determines that the video signals S1 and S2 are noninterlaced signals. Thus, the timing control circuit 10 drives the display device driving circuit 9 so as to display video signals S5 and S6 on the display device 7 from the point BD in FIG. 6C. Accordingly, input noninterlaced signals are also noninterlace-displayed on the display device 7.

In general, when display pixels provide a resolution called XGA (extended Graphic Array), the display device 7 is constituted by display pixels which form one frame by 1,024×768 pixels. For an input video signal of 640×480 pixels, the number of pixels of the input video signal must be increased by 1.6 times in both the vertical and horizontal directions. Since the screen is usually raster-scanned uniformly in the horizontal direction, display pixels can be easily interpolated by a direct interpolation method or the like, and the horizontal position always starts from the left end of the screen.

The vertical screen position always starts from the upper side of the screen for a noninterlaced signal, whereas the position of the start point BI of the first video signal changes every field for an interlaced signal. In 2:1 interlaced scanning, the positions of odd and even fields are displayed with a vertical shift of a ½line on the display device, as shown in FIG. 4. In a general display apparatus, a circuit is constituted to display fields with a shift of ½by ½-shifted scan in accordance with the magnification of input and output resolutions.

The present invention measures and stores the start point BI of the first video signal (time Ts from the vertical sync signal VD). Odd and even fields are different in the time Ts by a ½line. Letting Td (FIG. 5A) be this time difference using the first field as a reference, an arithmetic expression:

{Td÷ (Horizontal Sync Period)}×Magnification can be used to obtain the first scan line position in the next even field.

This operation can reproduce a scan line position in each field from the temporal viewpoint. With this operation, the present invention can cope with not only 2:1 interlaced scanning, but also any scan method such as 3:1 or 4:1 interlaced scanning according to an input signal.

This embodiment records the temporal relationship between the horizontal sync signal HD and vertical sync signal VD of an input signal for each field, and displays an image so as to faithfully reproduce the recorded temporal relationship in display operation on the display device 7. Hence, an image of a 2:1-interlaced signal can be accurately displayed when a horizontal equivalent pulse is generated around the vertical sync signal VD, or when a noise is generated around the vertical sync signal VD of a playback signal from a video tape recorder or the like. Further, even an image of a multivalued interlaced signal such as a 3:1- or 4:1-interlaced signal, which is difficult to display in a conventional apparatus, can be displayed.

The conventional apparatus switches noninterlace and interlace settings by the frequency of the sync signal of an input signal, but the present invention eliminates this switching operation. In the conventional apparatus, an interlaced signal may cause an error if noise is superposed on the horizontal sync signal HD around the vertical sync signal VD. However, the present invention determines the position of a video signal by measuring the time from the vertical sync signal VD, so that an interlaced signal does not cause any error due to noise.

As has been described above, the present invention sets the display position of the first video signal to be displayed on the display device on the basis of the temporal relationship between a time from the generation time of a vertical sync signal to input of the first video signal, and the generation time of a horizontal sync signal. The present invention can convert the resolution of an input signal into that of the display device to display the converted signal without performing field detection of an input signal or the like.

What is claimed is:

1. A video display apparatus comprising:
a display device;
resolution conversion means for converting a resolution of an input video signal into a resolution of said display device; and
display position setting means for setting a display position of a first video signal in each field to be displayed on said display device on the basis of a temporal relationship between a time from generation of a vertical sync signal to input of a first video signal and a generation timing of a horizontal sync signal.

2. An apparatus according to claim 1, wherein said display position setting means sets a time from generation of the horizontal sync signal to display of the first video signal on said display device on the basis of the time from generation of the vertical sync signal to input of the first video signal

3. An apparatus according to claim 1, wherein said display position setting means comprises:
time measurement means for measuring a time from the vertical sync signal to a position at which display starts;
display position calculation means for monitoring the temporal relationship between the measured time output from said time measurement means and a horizontal sync signal generated immediately after the vertical sync signal, and calculating a vertical display position of the input video signal; and
display position control means for changing the display position of a video signal on said display device for each field on the basis of outputs from said time measurement means and said display position calculation means in displaying the video signal output from said resolution conversion means on said display device.

4. An apparatus according to claim 3, wherein, for a 2:1-interlace display method, said display position calculation means determines a video signal of an odd field when an end timing of the measured time is immediately after the horizontal sync signal, and determines a video signal of an even field when the end timing of the measured time is an almost intermediate point between two horizontal sync signals.

5. An apparatus according to claim 4, wherein said display position control means sets a display start timing of the video signal immediately after a horizontal sync signal generated immediately after the vertical sync signal when the video signal is an odd field, and sets the display start timing of the video signal between two horizontal sync signals generated immediately after the vertical sync signal when the video signal is an even field.

6. An apparatus according to claim 3, wherein
said apparatus further comprises memory means for storing the time measured by said time measurement means for each field, and
said display position control means controls a display start timing of the video signal for each field using the time stored in said memory means.

7. An apparatus according to claim 1, wherein the input video signal includes an interlaced signal.

8. An apparatus according to claim 7, wherein the input video signal includes an N:1-interlaced signal (N is a positive integer of not less than 2).

9. An apparatus according to claim 1, wherein the input video signal includes a noninterlaced signal.

10. An apparatus according to claim 1, wherein said display device includes a display device having a plurality of display pixels arrayed in a dot matrix.
